(19) United States
(12) Patent Application Publication
(10) Pub. No.: US 2012/0314141 A1
(43) Pub. Date: Dec. 13, 2012

(54) LIGHTING DEVICE, DISPLAY DEVICE AND TELEVISION RECEIVER

(75) Inventor: Yasumori Kuromizu, Osaka-shi (JP)

(73) Assignee: SHARP KABUSHIKI KAISHA, Osaka-shi, Osaka (JP)

(21) Appl. No.: 13/579,289

(22) PCT Filed: Feb. 3, 2011
(86) PCT No.: PCT/JP2011/052211

§ 371 Date: Aug. 16, 2012

(30) Foreign Application Priority Data
Mar. 11, 2010 (JP) 2010-054876

(51) Int. Cl. F21V 8/00; G02F 1/13357; H04N 3/14; F21V 13/02

(52) U.S. Cl. 348/790; 362/613; 362/606; 362/609; 362/612; 362/602; 349/65; 348/E03.017

(57) ABSTRACT

An object of the present invention is to provide a lighting device in which uneven brightness is less likely to occur. The lighting unit 12 according to the present invention includes LEDs 17, a light guide member 19, and a positioning member 23. The light guide member 19 has an end portion facing the LEDs 17 as light sources. The positioning member 23 is capable of positioning the light guide member 9 with respect to a planar direction thereof. The end portion of the light guide member 19 includes a cutout 24 through which the positioning member 23 is inserted. The cutout 24 has a shape that narrows as a distance from the LED 17 increases. With this configuration, light from the LED 17 hardly enter the cutout 24 compared with a cutout having a constant width.

### TECHNICAL FIELD

The present invention relates to a lighting device, a display device and a television receiver.

### BACKGROUND ART

For example, a liquid crystal panel used for a liquid crystal display device such as a liquid crystal television does not emit light, and thus a backlight unit is required as a separate lighting device. The backlight unit is arranged behind the liquid crystal panel (on a side opposite to a display surface side). The backlight unit includes a chassis having an opening on its surface side facing the liquid crystal panel, a light source housed in the chassis, and an optical member (such as a diffuser sheet) provided in the opening of the chassis for effectively exit light emitted from the light source toward the liquid crystal side. As an example of such a backlight unit, the backlight unit in which the optical member is positioned with respect to a planar direction is disclosed in Patent Document 1, for example. This backlight unit includes a positioning pin on a receiving member receiving the optical member. The positioning pin is inserted through a through hole formed in the optical member to position the optical member with respect to a planar direction.

### RELATED ART DOCUMENT

### Patent Document

Patent Document 1: Japanese Unexamined Patent Publication No. 2009-139572

### PROBLEM TO BE SOLVED BY THE INVENTION

However, the backlight unit described in Patent Document 1 is a direct backlight unit in which light sources are arranged right behind an optical member. In a current situation, an edge-light type backlight unit that includes a light guide member and light sources arranged on an end portion of the light guide member has not been sufficiently studied.

### DISCLOSURE OF THE PRESENT INVENTION

The present invention was accomplished in view of the above circumstances. It is an object of the present invention to provide a lighting device in which uneven brightness is less likely to occur.

### MEANS FOR SOLVING THE PROBLEM

A lighting device includes light sources, a light guide member, and a positioning member. The light guide member has an end portion facing the light source. The end portion includes a cutout in a shape that narrows as a distance from the light source increase. The positioning member is inserted through the cutout and is capable of positioning the light guide member with respect to a planar direction thereof.

With the above configuration, the positioning member is inserted into the cutout formed in the light guide member, and thus the light guide member can be positioned with respect to the planar direction thereof. Accordingly, a positional relationship between the light guide member and the light source can be held constant. As a result, light entrance efficiency of the light entering the light guide member from the light source can be stabilized, and thus uneven brightness is less likely to occur. Additionally, according to the present invention, the cutout formed in the end portion of the light guide member is in a shape that narrows as a distance from the light source increases. With this configuration, the light reaching the end portion of the light guide member from the light source hardly enters the inside of such a cutout, compared with a cutout having a constant width. The light reaching the end portion of the light guide member may travel into the cutout having a constant width. In such a case, the light may be reflected (including total reflection) or refracted by an interface of the cutout. This may cause unevenness in a distribution of the light traveling in the light guide member. As a result, a part of the light guide member may become a dark portion in which the amount of light is locally small, and thus uneven brightness may occur. However, according to the present invention, the light reaching the end portion of the light guide member hardly enter the inside of the cutout, and thus the unevenness in the distribution of the light traveling in the light guide member is less likely to occur. Accordingly, the dark portion, i.e., the uneven brightness is less likely to occur in the light guide member.

The following configurations may be preferably employed as embodiments of the present invention.

(1) The light sources are separately arranged on a line along the end portion of the light guide member. The positioning member and the cutout are not aligned with any of the light sources on the line on which the light sources are arranged. With this configuration, the light from the light sources efficiently enters the end portion of the light guide member, because the light sources are separately arranged on a line along the end portion of the light guide member. Further, the light from the light sources hardly enter the cutout, because the positioning member and the cutout are not aligned with any of the light sources on the line on which the light sources are arranged. Accordingly, uneven brightness is less likely to occur.

(2) The positioning member and the cutout are arranged between the adjacent light sources. This configuration is advantageous when there is no space for the cutout on an end of a dimension of the light guide member along an arrangement direction in which the light sources are arranged. In addition, even if the space between the adjacent light sources is reduced, the light from the light sources still hardly enter the cutout compared with the cutout having the constant width, because the cutout is in a shape that narrows as a distance from the light source increases. The density of the light sources can be increased by narrowing the space between the light sources, and thus the brightness can be improved.

(3) The adjacent light sources are equally spaced apart from the positioning member and the cutout that are arranged therebetween. With this configuration, the light from each of the adjacent light sources hardly enter the cutout, and thus uneven brightness is less likely to occur.

(4) The cutout is symmetrical with respect to a symmetric line passing through a midpoint between the adjacent light sources. With this configuration, the interfaces of the cutout have the same positional relationship with respect to the adjacent light sources. As a result, uneven brightness is less likely to occur.

(5) The positioning member and the cutout includes a plurality of positioning members and a plurality of cutouts, respectively. Each of the plurality of positioning members is paired up with corresponding one of the plurality of cutouts. The positioning members and the cutouts are arranged such that a distance between the pair of the positioning member and the cutout and the adjacent pair of the positioning member and the cutout is larger than an interval between the adjacent light sources. With this configuration, the light guide member can be properly positioned, because a plurality of pairs of the positioning members and the cutouts are provided. Further, the cutout and the positioning member that may form a dark portion are more sparsely arranged than the light sources, and thus uneven brightness is less likely to occur.

(6) The cutout is provided close to an end of a dimension of the light guide member along an arrangement direction in which the light sources are arranged. With this configuration, uneven brightness is less likely to occur compared with the case that the cutout is arranged at a middle in the arrangement direction of the light sources, because the cutout that may form a dark portion is arranged at the end of a dimension along the arrangement direction of the light sources.

(7) The cutout is provided close to each end of the dimension of the light guide member along the arrangement direction of the light sources. With this configuration, uneven brightness is less likely to occur and the light guide member is properly positioned.

(8) The lighting device further includes an optical member covering a light exit surface of the light guide member. The optical member includes a cutout that is communicated with the cutout of the light guide member and through which the positioning member is inserted. By inserting the positioning member through the cutout of the light guide member and the cutout of the optical member, the light guide member and the optical member can be positioned at the same time.

(9) The cutout of the optical member is a hole extending through the optical member in the thickness direction thereof, and an edge of the hole is supported by the positioning member with respect to the vertical direction. By inserting the positioning member through the cutout of the optical member, the edge of the hole of the cutout is supported by the positioning member with respect to the vertical direction. In other words, the optical member is suspended and supported by the positioning member. Thus, even if the optical member is thermally expanded or thermally contracted, the optical member is less likely to be subjected to deformation such as wrinkling and warping due to its own weight. Thus, uneven brightness is less likely to occur.

(10) The cutout of the optical member is formed in an upper end portion of the optical member in a vertical position. With this configuration, the upper end portion of the optical member can be suspended and supported by the positioning member. As a result, the optical member is less likely to be subjected to deformation such as wrinkling and warping substantially over the entire area in the vertical direction. Thus, uneven brightness is less likely to occur.

(11) The light sources are provided so as to face both of the upper end portion and a lower end portion of the light guide member in a vertical position. With this configuration, brightness can be improved. Even if the size of the backlight unit is increased, sufficient brightness can be achieved. As a result, the size of the backlight unit can be increased.

(12) The cutout of the light guide member has an opening toward the light source side. With this configuration, the positioning member can be easily inserted through the cutout, compared with a cutout having a closed outer periphery. This facilitates the assembly.

(13) The opening of the cutout of the light guide member has the width that gradually decreases as a distance from the light source increases. With this configuration, the light from the light source hardly enter the cutout.

(14) The cutout of the light guide member has a triangular shape in a plan view. With this configuration, the interface of the cutout is inclined with respect to an arrangement direction in which the light source and the light guide member are arranged. Thus, the light from the light source is less likely to enter the cutout.

(15) The cutout of the light guide member has an isosceles triangle shape in a plan view. The cutout has a symmetrical shape in this configuration. Thus, this configuration is preferable when two light sources are arranged so as to sandwich the cutout.

(16) The cutout of the light guide member has a trapezoidal shape in a plan view. In this configuration, the interface of the cutout partially inclined with respect to an arrangement direction in which the light source and the light guide member are arranged. Thus, the light emitted from the light source hardly enter the cutout.

(17) The cutout of the light guide member has a substantially semicircular shape in a plan view. With this configuration, the interface of the cutout has an arc-like shape, and thus the light emitted from the light source hardly enter the cutout.

(18) The cutout of the light guide member has a substantially semielliptical shape in a plan view. With this configuration, the shape of the interface of the cutout can be readily changed depending on the positional relationship between the light source and the cutout.

(19) The cutout extends through the light guide member in the thickness direction thereof. The cutout can be readily formed through the light guide member in this configuration. This is advantageous in the production of the light guide member.

(20) The lighting device further include the chassis housing the light source and the light guide member. The positioning member is integrally formed with the chassis. With this configuration, the light guide member is positioned by the positioning member, and thus the appropriate positional relationship between the light sources and the light guide member can be maintained.

(21) The lighting device further includes the chassis housing the light sources and the light guide member, and a frame attached to the chassis. The frame is capable of holding down the light guide member from a light exit side. The positioning member is integrally formed on the frame. With this configuration, the light guide member is positioned by the positioning member that is integrally formed on the frame, and thus an appropriate positional relationship between the light sources and the light guide member can be maintained.

(22) The positioning member has a columnar shape. With this configuration, the positioning member can be readily inserted through the cutout, and thus this configuration facilitates the assembly.

(23) The lighting device further includes a reflector covering a surface opposite to a light exit surface of the light guide member. The reflector includes a through hole that is communicated with the cutout of the light guide member and through which the positioning member is inserted. The light traveling in the light guide member can be reflected toward the light exit side by the reflector, and thus the light can efficiently exit from the light guide member. By inserting the positioning member through the cutout of the light guide member and the through hole, not only the light guide member, but also the reflector can be positioned.

(24) The lighting device further includes a light source board on which the light sources are mounted. With this configuration, the arrangement of the light sources and wiring of the light sources can be facilitated.

(25) The light sources may be LEDs. This improves brightness and reduces power consumption.

Next, to solve the above problem, a display device of the present invention may include the above lighting device and a display panel configured to provide display using light from the lighting device.

In such a display device, the lighting device that supplies light to the display panel is less likely to cause unevenness in the exiting light. This achieves display having high display quality.

The display panel may be a liquid crystal panel. The display device as a liquid crystal display device has a variety of applications, such as a television display or a personal-computer display. Particularly, it is suitable for a large screen display.

### ADVANTAGEOUS EFFECT OF THE INVENTION

According to the present invention, uneven brightness is less likely to occur.

### BRIEF DESCRIPTION OF THE DRAWINGS

FIG. 1 is an exploded perspective view illustrating a general configuration of a television receiver according to the first embodiment of the present invention;

FIG. 2 is an exploded perspective view illustrating a general configuration of a liquid crystal display device included in the television receiver;

FIG. 3 is an exploded perspective view illustrating a relationship among the chassis, the light guide member, and the optical member included in the backlight unit of the liquid crystal panel;

FIG. 4 is a plan view illustrating a state in which the chassis included in the backlight unit houses the light guide member and the LED board;

FIG. 5 is a cross-sectional view taken along a v-v line in FIG. 4;

FIG. 6 is a cross-sectional view taken along a vi-vi line in FIG. 4;

FIG. 7 is a cross-sectional view taken along a vii-vii line in FIG. 4;

FIG. 8 is an magnified plan view illustrating a specific positional relationship among the LED, the light guide member (the cutout), and the positioning member;

FIG. 9 is a magnified plan view illustrating a specific positional relationship among the LED, the light guide member (the cutout), and the positioning member according to the first modification of the first embodiment;

FIG. 10 is a magnified plan view illustrating a specific positional relationship among the LED, the light guide member (the cutout), and the positioning member according to the second modification of the first embodiment;

FIG. 11 is a magnified plan view illustrating a specific positional relationship among the LED, the light guide member (the cutout), and the positioning member according to the third modification of the first embodiment;

FIG. 12 is a magnified plan view illustrating a specific positional relationship among the LED, the light guide member (the cutout), and the positioning member according to the fourth modification of the first embodiment;

FIG. 13 is a magnified plan view illustrating a specific positional relationship among the LED, the light guide member (the cutout), and the positioning member according to the fifth modification of the first embodiment;

FIG. 14 is a plan view illustrating a state in which the chassis included in the backlight unit according to the second embodiment of the present invention houses the light guide member and the LED board;

FIG. 15 is a cross-sectional view illustrating a cross-sectional configuration taken along the short-side direction of the liquid crystal display device according to the third embodiment of the present invention;

FIG. 16 is a plan view illustrating a state in which the chassis included in the backlight unit according to the fourth embodiment of the present invention houses the light guide member and the LED board;

FIG. 17 is a plan view illustrating a state in which the chassis included in the backlight unit according to the other embodiment (1) of the present invention houses the light guide member and the LED board; and

FIG. 18 is a cross-sectional view illustrating a cross-sectional configuration taken along the short-side direction of the liquid crystal display device according to the other embodiment (2) of the present invention.

### MODE FOR CARRYING OUT THE INVENTION

### First Embodiment

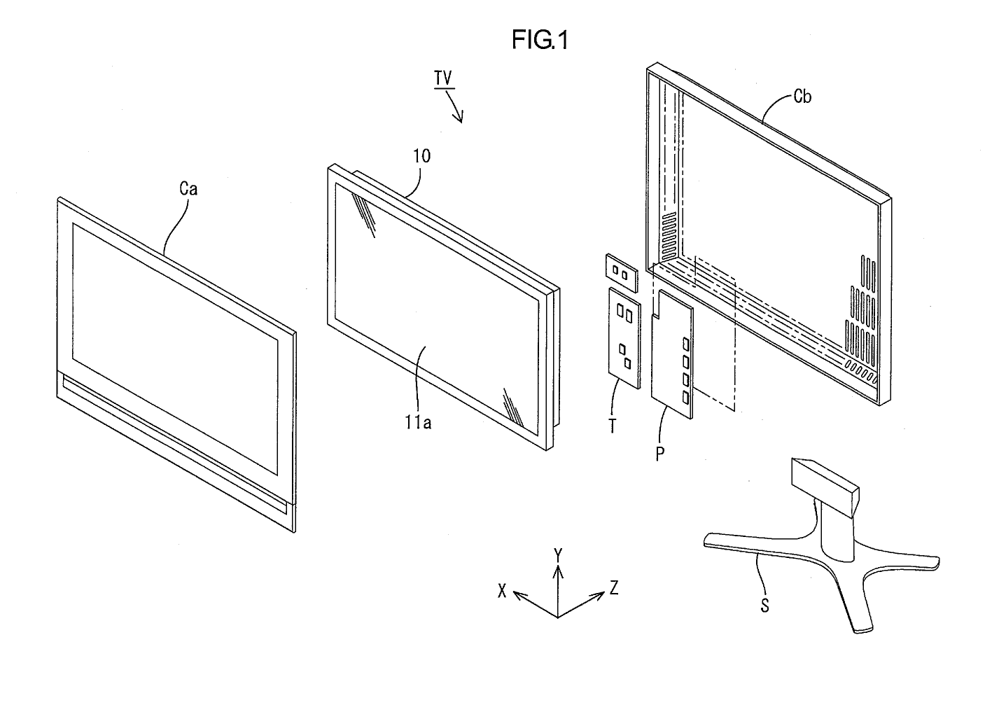

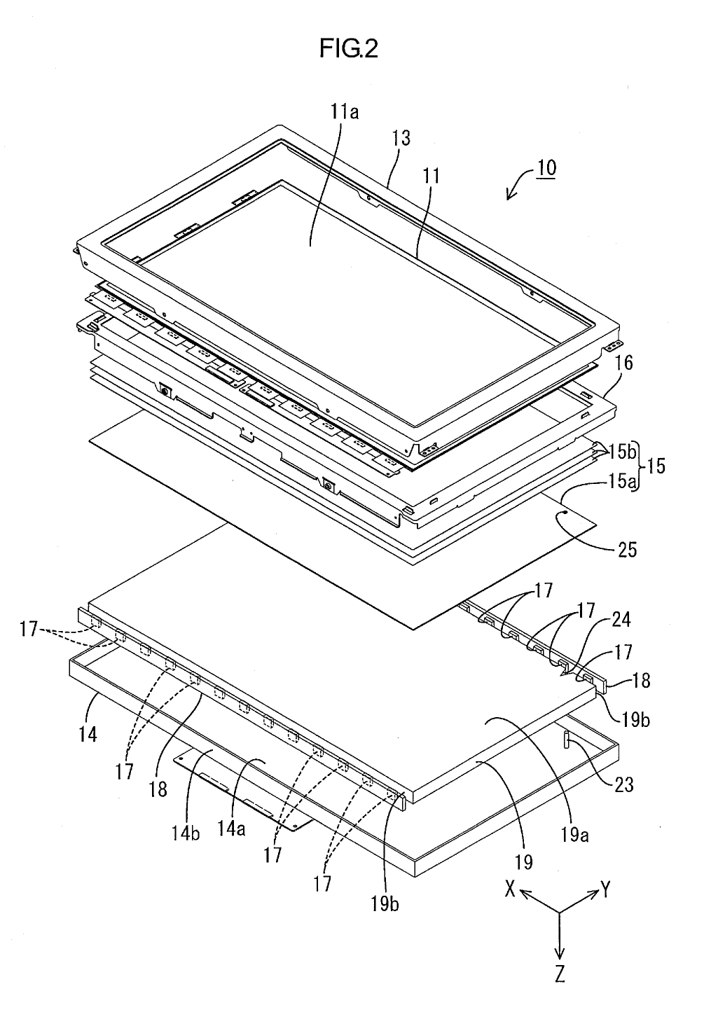

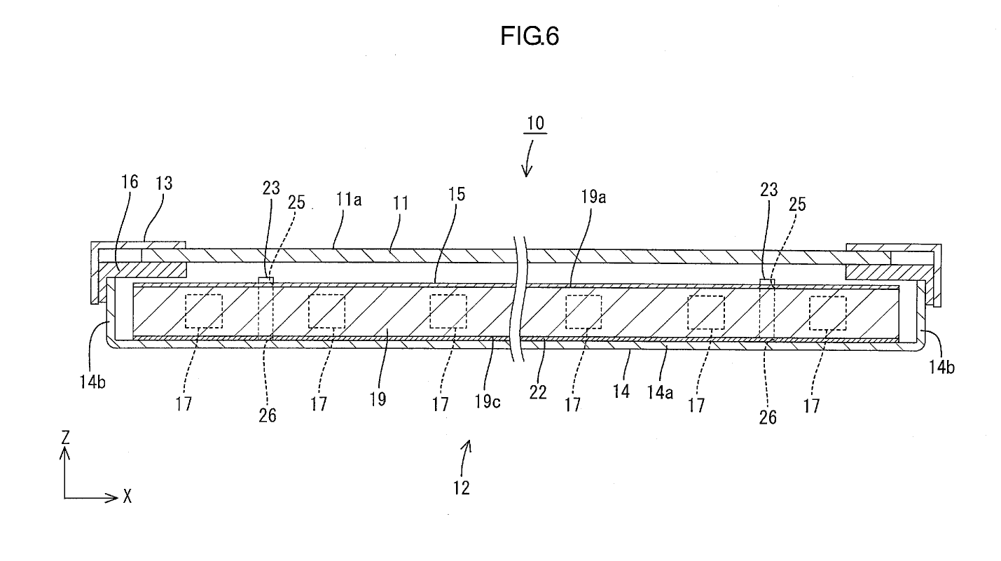

A first embodiment of the present invention will be described with reference to FIGS. 1 to 8. In this embodiment, a liquid crystal display device 10 will be explained. An X-axis, a Y-axis and a Z-axis are described in a part of the drawings, and a direction of each axial direction corresponds to a direction described in each drawing. The Y-axis direction and the X-axis direction, respectively, correspond to a vertical direction and a horizontal direction. The description of upper and lower side is based on the vertical direction unless otherwise specified. Additionally, the upper side in FIG. 2 corresponds to a front side, and the lower side therein corresponds to a rear side.

As illustrated in FIG. 1, a television receiver TV according to the present embodiment includes a liquid crystal display device 10, front and back cabinets Ca and Cb, a power supply P, a tuner T, and a stand S. The front and back cabinets Ca and Cb sandwich, and thus house, the liquid crystal display device 10. The liquid crystal display device (display device) 10 has a landscape (elongated) quadrangular shape (rectangular shape) as a whole. The liquid crystal display device 10 is housed in a vertical position such that a display surface 11a thereof extends along the vertical direction (Y-axis direction). As illustrated in FIG. 2, the liquid crystal display device 10 includes a liquid crystal panel 11 as a display panel, and a backlight unit (lighting device) 12 as an external light source. The liquid crystal panel 11 and the backlight unit 12 are integrally held by a frame shaped bezel 13 and the like.

Herein, the phrase “the display surface 11a of the liquid crystal panel 11 extends along the vertical direction” refers not only the display surface 11a of the liquid crystal panel 11 is in the vertical position, but also the display surface 11a is set in a position closer to the vertical position than the horizontal position. The display surface 11a may be tilted at 0 to 45 degrees, preferably 0 to 30 degrees, with respect to the vertical direction.

As illustrated in FIG. 2, the liquid crystal panel 11 has a landscape (elongated) quadrangular (rectangular) shape in a plan view and is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as red (R), green (G) and blue (B) color sections arranged in a predetermined pattern, counter electrodes, and an alignment film and the like are provided. Polarizing plates are attached to outer surfaces of the substrates.

As illustrated in FIG. 2, the backlight unit 12 includes a chassis 14, an optical sheet set 15 (a diffuser (light diffuser member) 15a and a plurality of optical sheets 15b provided between the diffuser 15a and the liquid crystal panel 11). The chassis 14 has a substantially box-shape and has an opening on a light exit side (on a liquid crystal panel 11 side). The optical sheet set 15 is provided so as to cover the opening of the chassis 14. The chassis 14 houses a plurality of LEDs 17 (Light Emitting Diode) as light sources, an LED board 18 on which the LEDs 17 are mounted, a light guide member 19 configured to guide the light emitted from the LED 17 to the optical member 15 (the liquid crystal panel 11), and a frame 16 capable of holding down the light guide member 19 from the front side. The backlight unit 12 is an edge-light type (side-light type) backlight unit in which the LED board 18 on which the LEDs 17 are mounted is provided on upper and lower ends of the backlight unit 12 in the vertical position (the end portions along the long side), and the light guide plate 18 is provided between the LED boards 18 so as to be positioned at the middle in the vertical direction. Hereinafter, components of the backlight unit 12 will be described in detail.

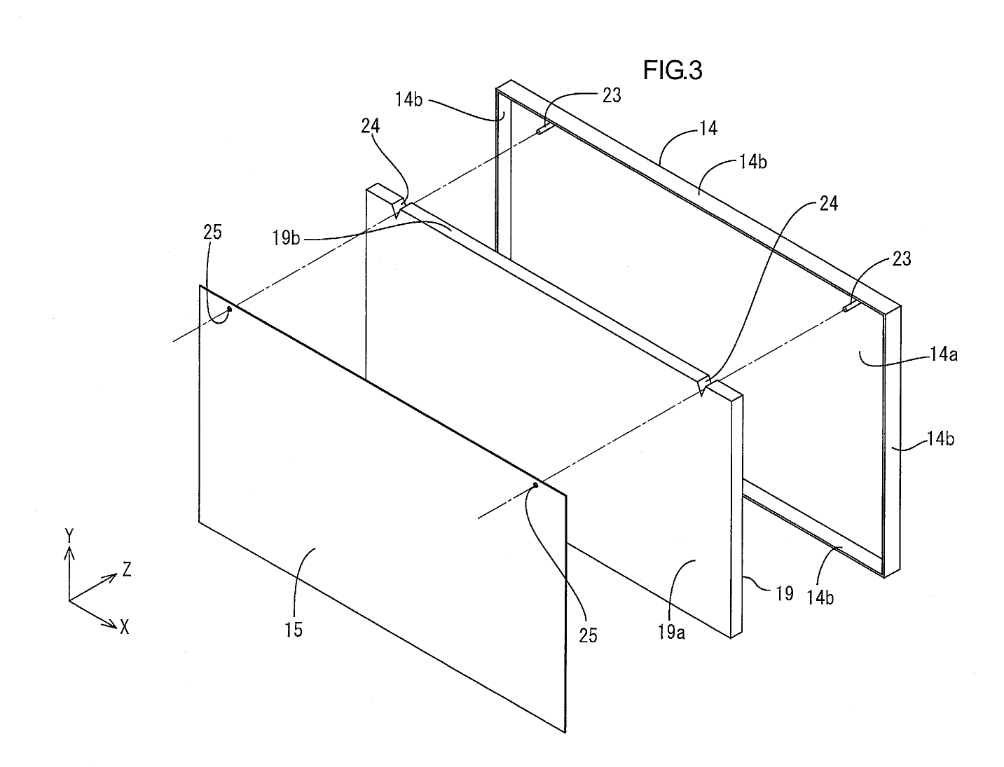

The chassis 14 is made of metal. As illustrated in FIGS. 2 and 3, the chassis 14 includes a bottom plate 14a having a landscape quadrangular shape like the liquid crystal panel 11 and a pair of side plates 14b each of which rises from an outer edge of the corresponding side of the bottom plate 14a. A long-side direction of the chassis 14 (the bottom plate 14a) matches an X-axis direction (a horizontal direction) and a short-side direction thereof matches a Y-axis direction (a vertical direction). The frame 16 and the bezel 13 can be screwed to the side plates 14b.

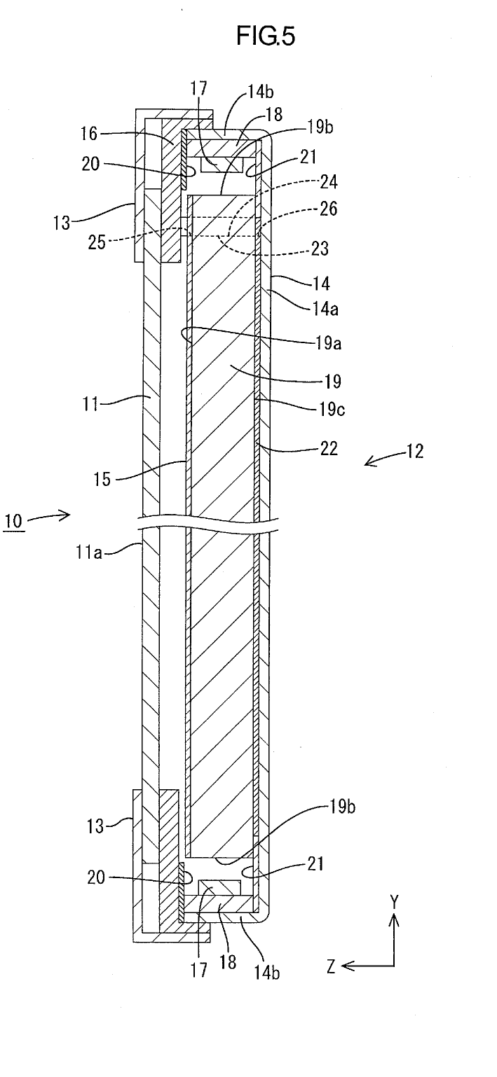

As illustrated in FIG. 2, the optical member 15 has a landscape quadrangular shape in a plan view like the liquid crystal panel 11 and the chassis 14. The optical member 15 is provided on the front side (the light exit side) of the light guide member 19 and arranged between the crystal liquid panel 11 and the light guide member 19. The optical member 15 includes a diffuser plate 15a at the rear side (the light guide member 19 side, the side opposite to the light exit side) and optical sheets 15b at the front side (the liquid crystal panel 11 side, the light exit side). The diffuser plate 15a includes a substantially transparent plate-like resin base member having a predetermined thickness and diffuser particles dispersed in the base member. The diffuser plate 15a has a function of diffusing the light passing therethrough. The optical sheet 15b has a sheet-like shape having a thickness smaller than that of the diffuser plate 15a. Three optical sheets 15b are laminated on each other. Specific examples of the optical sheet 15b include a diffuser sheet, a lens sheet, and a reflection-type polarizing sheet, and any one of them may be appropriately selected to be used. The optical member 15 is simplified in FIG. 3, FIG. 5 to FIG. 7. Specifically, the optical member 15 including a plurality of sheets (four sheets) is illustrated as one sheet.

As illustrated in FIG. 2, the frame 16 has a frame shape extending along an outer peripheral portion of the light guide member 19. The substantially entire outer peripheral portion of the light guide member 19 can be held down by the frame 16 from the front side. The frame 16 is made of synthetic resin and has a black surface so as to have light shielding properties. As illustrated in FIG. 5, first reflection sheets 20 that reflect light are each provided on a rear surface of a long side of the frame 16, i.e., a surface facing the light guide member 19 and the LED board 18 (the LEDs 17). The first reflection sheet 20 extends over substantially entire length of the long side of the frame 16. The first reflection sheet 20 is in contact with an end portion of the light guide member 19 on the LED side and collectively covers the end portion and the LED board 18 from the front side. The frame 16 receives an outer peripheral portion of the liquid crystal panel 11 from the rear side.

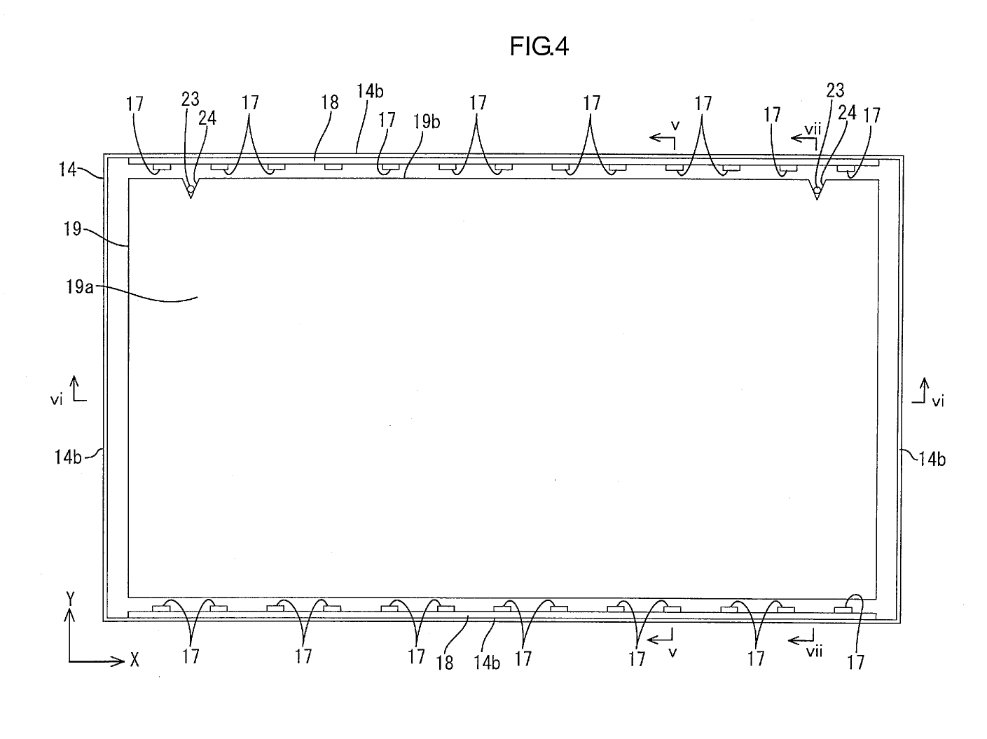

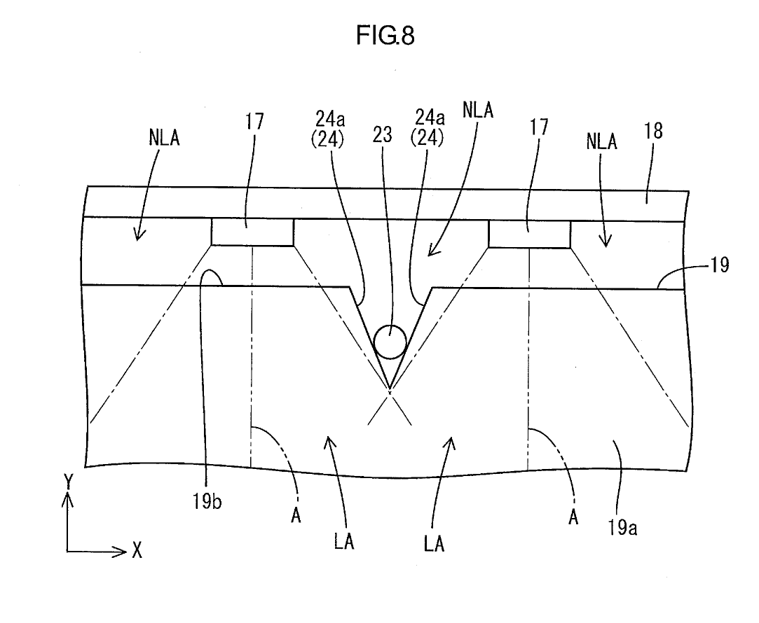

As illustrated in FIG. 2, FIG. 4, and FIG. 5, the LED 17 is configured by sealing a LED chip on abase member fixed to the LED board 18, with a resin material. The LED chip mounted on the base member has one main light emission wavelength and specifically, the LED chip that emits a single color of blue is used. A fluorescent material is dispersed in the resin material that seals the LED chip to emit a specific color, a white color as a whole, by being excited by blue light emitted by the LED chip. Examples of fluorescent material include a yellow fluorescent material that emits yellow light, a green fluorescent material that emits green light, and a red fluorescent material that emits red light. Such fluorescent materials may be appropriately used in combination or alone. The LED 17 is a top-type LED that has a light emitting surface on a side opposite from the surface that is mounted to the LED board 18. Light emitted from the LED 17 radiates around a light axis A within a specified angle range. The light axis A is indicated by a two-dotted chain line in FIG. 8. In FIG. 8, an irradiation area LA is defined by a pair of one-dotted chain lines with the light axis A being located therebetween. The one-dotted chain line in FIG. 8 indicates the outermost of the irradiation area LA.

The LED board 18 is made of synthetic resin (such as epoxy resin) or ceramic. As illustrated in FIG. 2 and FIG. 4, the LED board 18 has an elongated plate shape extending along the long-side direction of the chassis 14 (the end portion of the light guide member 19 on the LED side, the X-axis direction, the horizontal direction). The LED board 18 is housed in the chassis 14 with a main plate surface thereof being oriented parallel to the X-axis direction and the Z-axis direction, in other words, with a main surface thereof being arranged perpendicular to a plate surface of the liquid crystal panel 11 and the light guide member 19 (the optical member 15). The long-side direction and the short-side direction of the main plate surface of the LED board 18 match the X-axis direction and the Z-axis direction, respectively, and the thickness direction thereof that is perpendicular to the main plate surface match the Y-axis direction.

As illustrated in FIG. 2 and FIG. 4, the LED board 18 is provided on the upper and lower ends of the chassis 14 in the vertical direction (the Y-axis direction) so as to sandwich the light guide plate 19 therebetween. The LED board 18 is screwed to the side plate 14b that is provided on upper and lower sides of the chassis 14 in the vertical direction, for example. A plurality of LEDs 17 (thirteen LEDs 17, in FIG. 2) are arranged on a main plate surface of the LED board 18 that faces the light guide member 19 (a surface that faces the light guide member 19). The LEDs 17 are separately arranged along the long-side direction of the LED board 18 (the end portion of the light guide member 19 on the LED side, the X-axis direction, the horizontal direction). Intervals between the adjacent LEDs 17 in the X-axis direction, i.e., arrangement intervals of the LEDs 17, are substantially constant. The LED boards 18 are housed in the chassis 14 such that the surfaces of the respective LED boards 18 on which the LEDs 17 are mounted face each other. Accordingly, the light emitting surfaces of the respective LEDs 17 mounted on the LED boards 18 face each other. The light axes of the LEDs 17 substantially match the vertical direction (the Y-axis direction). In other words, the LEDs 17 mounted on the pair of LED boards 18 are arranged so as to face the upper and lower end portions (the end portions along the long side) of the light guide plate 19 in the vertical direction. The LED board 18 may be made of metal material such as aluminum material like the chassis 14 and a wiring pattern may be formed on a surface of the LED board 18 with an insulating layer provided therebetween.

The light guide member 19 is made of substantially transparent (high light transmissive) synthetic resin (such as acrylic) that has a refractive index higher than air. As illustrated in FIG. 2, the light guide member 19 has a plate like shape that is a landscape quadrangular shape in a plan view like the liquid crystal panel 11 and the chassis 14. The long-side direction and the short-side direction of the main plate surface of the light guide member 19 match the X-axis direction (the horizontal direction, the arrangement direction of the LEDs 17) and the Y-axis direction (the vertical direction), respectively, and the thickness direction perpendicular to the main plate surface matches the Z-axis direction. As illustrated in FIG. 5, the light guide member 19 is arranged right behind the liquid crystal panel 11 and the optical member 15 in the chassis 14. The light guide member 19 is sandwiched between the pair of LED boards 18 that is each provided on the upper and lower ends of the chassis 14. Accordingly, an arrangement direction in which the LED 17 (the LED board 18) and the light guide member 19 are arranged matches the Y-axis direction (the vertical direction) and an arrangement direction in which the optical member 15 (the liquid crystal panel 11) and the light guide member 19 are arranged matches the Z-axis direction. The above two arrangement directions are perpendicular to each other. Light emitted from the LEDs 17 in the Y-axis direction enters the light guide member 19 and travels through the light guide member 19 to direct the light toward the optical member 15 (in the Z-axis direction). The light guide member 19 has a size substantially same as the above-described optical member 15 in a plan view. The outer peripheral portion of the light guide member 19 is held down indirectly by the frame 16 from the front side with the optical member 15 therebetween.

As illustrated in FIG. 3, the main plate surface of the light guide member 19 that faces the front side (the surface covered by the optical member 15) is a light exit surface 19a from which the light in the light guide member 19 exits toward the optical member 15 and the liquid crystal panel 11. In other words, the optical member 15 is arranged between the light exit surface 19a of the light guide member 19 and the liquid crystal panel 11. Among outer peripheral surfaces of the light guide member 19 that are adjacent to the main plate surface, upper and lower end surfaces (the long-side end surfaces having an elongated shape along the X-axis direction) face the LEDs 17 (the LED board 18) with a predetermined space therebetween. The upper and lower surfaces are each referred to as the light entrance surface 19b through which the light emitted from the LED 17 enters. As illustrated in FIG. 5, the above-described first reflection sheet 20 is provided on the front side of the space defined by the LEDs 17 and the light entrance surface 19b, and a second reflection sheet 21 is provided on the rear side of the space such that the first reflection sheet 20 and the second reflection sheet 21 sandwich the space. In addition to the above space, the first and second reflection sheets 20, 21 sandwich the end portion of the light guide member 19 and the LED 17. With this configuration, the light emitted from the LED 17 is repeatedly reflected by the first and second reflection sheets 20, 21, and thus the light can effectively enter the light entrance surface 19b. The light entrance surface 19b extends parallel to the X-axis direction and the Z-axis direction (the main plate surface of the LED board 18) and substantially perpendicular to the light exit surface 19a. An arrangement direction in which the LED 17 and the light entrance surface 19b are arranged matches the Y-axis direction (vertical direction) and is parallel to the light exit surface 19a.

A light-guide reflection sheet 22 is provided on a surface 19c opposite to the light exit surface 19a of the light guide member 19 so as to cover the entire surface of the opposite surface 19c. The light-guide reflection sheet 22 reflects and guides the light in the light guide member 19 to the front side. In other words, the light-guide reflection sheet 22 is sandwiched between the bottom plate 14a of the chassis 14 and the light guide member 19. At least one of the light exit surface 19a and the surface 19c opposite to the light exit surface 19a of the light guide member 19 is patterned such that reflection portions (not illustrated) that reflect the light in the light guide member 19 or diffuser portions (not illustrated) that diffuse the light in the light guide member 19 are formed in a predetermined distribution. This enables the light exiting from the light exit surface 19a to be controlled in a uniform distribution.

As illustrated in FIG. 3, in the present embodiment, a positioning member 23 that positions the light guide member 19 is provided on the chassis 14, and a cutout 24 into which the positioning member 23 is inserted is provided in the light guide member 19. With this configuration, the light guide member 19 can be positioned with respect to the direction along the main plate surface thereof (the planar direction). In other words, the light guide member 19 can be positioned with respect to the chassis 14 and the LEDs 17 (the LED board 18) fixed to the chassis 14 in the X-axis direction and the Y-axis direction. The cutout 24 formed by cutting out a part of the light guide member 19 may adversely affect the light traveling in the light guide member 19. Specifically, the light reaching the light guide member 19 from the LED 17 may travel into the cutout 24, and the light may be reflected or refracted at an interface of the cutout 24 (including total reflection). This may cause an uneven distribution of the light transmitting in the light guide member 19. As a result, a portion of the light guide member 19 may become a dark portion in which the amount of light is locally small, and thus uneven brightness may occur. To solve this problem, the cutout 24 of the present embodiment is in a shape that narrows as a distance from the LED 17 increases. Hereinafter, the cutout 24 and the positioning member 23 will be described in detail.

As illustrated in FIG. 3 and FIG. 4, the cutout 24 is provided on an upper end portion (an upper end portion in FIG. 4) in the short-side direction of the light guide member 19, i.e., in the vertical direction (the Y-axis direction). The cutout 24 is provided on each end side in the long-side direction of the light guide member 19 (the X-axis direction, the arrangement direction of the LEDs 17). The distance (interval) between the cutouts 24 is slightly smaller than the length of the long side of the light guide member 19, but much larger than the interval between the adjacent LEDs 17 in the X-axis direction (arrangement interval of the LEDs 17). In other words, the cutout 24 is arranged more sparsely than the LEDs 17. The cutout 24 is arranged so as to be arranged between the adjacent LEDs 17 in the X-axis direction. Specifically described, among the LEDs 17 that are linearly arranged in the X-axis direction, the cutout 24 is arranged between the LED 17 that is positioned at the most distal end and the LED 17 that is adjacent to such an LED 17 and positioned on an inner side in the X-axis direction. More specifically described, the cutout 24 is arranged at a middle between these adjacent LEDs 17, i.e., the cutout 24 is arranged such that a distance from each of the adjacent LEDs 17 to the cutout 24 is equal. In other words, the cutout 24 is arranged at a position (off set position) that does not correspond to the LED 17 in the X-axis direction (the arrangement direction of the LEDs 17). The cutout 24 does not directly face the LED 17. The cutout 24 faces the LED 17 at an angle.

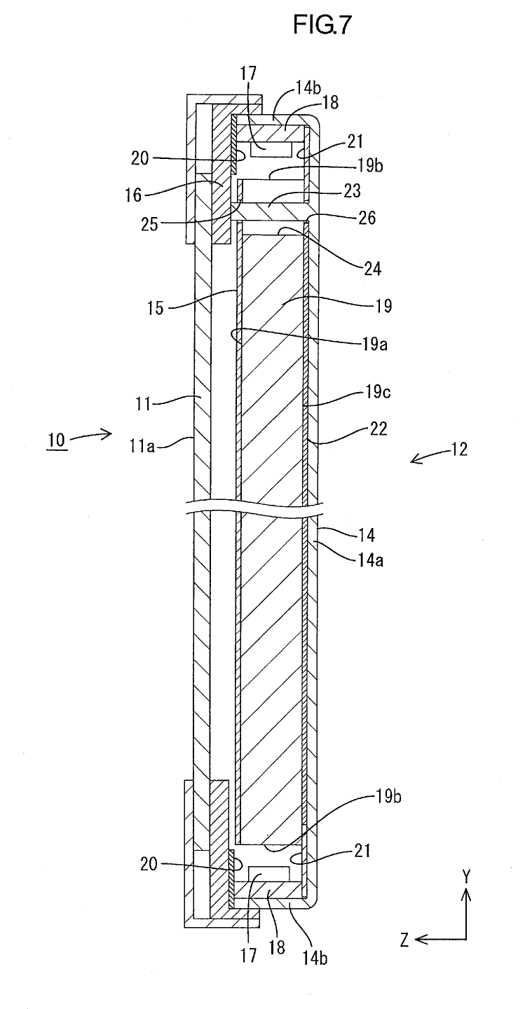

As illustrated in FIG. 7, the cutout 24 extends through the upper end portion of the light guide member 19 in the thickness direction (the Z-axis direction). The cutout 24 has an opening on the upper side (the upper side in FIG. 4 and FIG. 7) in the vertical direction (the Y-axis direction), i.e., an opening toward the LED 17 side. As illustrated in FIG. 8, the cutout 24 has a triangular shape in a plan view. The width of the opening (a dimension in the X-axis direction) becomes gradually smaller toward the lower side, i.e., become gradually smaller in a direction away from the LED 17. The cutout 24 is formed by cutting a part of the upper end portion of the light guide member 19 (the light entrance surface 19b) into a V-shaped groove. The cutout 24 has an isosceles triangle shape in a plan view and is symmetrical with respect to the symmetric line extending along the Y-axis direction and passing through the midpoint between the adjacent LEDs 17. Accordingly, a pair of side surfaces (interfaces) 24a of the cutout 24 is inclined with respect to the Y-axis, i.e., the light axis A of the LED 17 (the arrangement direction in which the LED 17 and the light guide member 19 are arranged), at the same inclination angle. The side surfaces 24a of the cutout 24 are interfaces to an outside air layer.

The side surfaces 24a of the cutout 24 is arranged so as not to overlap with the irradiation areas LA (one-dotted line in FIG. 8) of the adjacent LEDs 17 with the cutout 24 therebetween. In other words, the cutout 24 is arranged in a non-irradiation area NLA. The entire of the non-irradiation area NLA is arranged outside the irradiation areas LA of the adjacent LEDs 17. In such a configuration, the side surface 24a of the cutout 24 is inclined with respect to the light axis A of the LED 17, and the inclination angle thereof is smaller than the inclination angle of the one-dotted line in FIG. 8 with respect to the light axis A. The one-dotted line in FIG. 8 indicates the outermost position of the irradiation area LA. With this configuration, the light from the adjacent LEDs 17 hardly enter the cutout 24. Herein, the phrase “non-irradiation area NLA of the LED 17” refers to an area outside any one of the irradiation areas LA of the LEDs 17. In FIG. 8, the non-irradiation area NLA is a substantially V-shaped area between the adjacent one-dotted lines (the outermost positions of the irradiation area LA) that intersect with each other. The non-irradiation area NLA having a substantially V-shape has a larger angular range than the cutout 24 having a V-shape.

Next, the positioning member 23 will be explained. As illustrated in FIG. 3 and FIG. 4, the positioning member 23 is provided in a pair on the bottom plate 14a of the chassis 14. The pair of positioning members 23 is arranged at positions corresponding to the cutouts 24 formed in the light guide member 19, i.e., at each end side in the X-axis direction on the upper end portion of the chassis 14. The positioning member 23 has a substantially columnar shape protruding toward the front side along the Z-axis direction from the bottom plate 14a. As illustrated in FIG. 7, the protrusion of the positioning member 23 has a dimension longer than the total thickness of the light guide member 19 and the thickness of the optical member 15. As illustrated in FIG. 8, the positioning member 23 is inserted through the cutout 24 and is brought into contact with the side surfaces 24a thereof, and thus the light guide member 19 is positioned in the X-direction and the Y-axis direction with respect to the chassis 14 and the LEDs 17 fixed to the chassis 14. Particularly, the positioning member 24 and the cutout 24 are each provided in a pair on each end side in the long-side direction of the light guide member 19 such that the positioning member 24 and the cutout 24 correspond to each other. Thus, the light guide member 19 can be properly positioned and the rotation of the light guide member 19 can be prevented. The diameter of the positioning member 23 is smaller than the maximum width of the opening toward the LED 17 side of the cutout 24 (the width of the opening on the upper end of the light guide member 19). The positioning member 23 is integrally formed with the bottom plate 14a of the chassis 14.

As illustrated in FIG. 3, the optical member 15 laminated on the light exit side of the light guide member 19 has a second cutout 25 that is communicated with the above-described cutout 24 and through which the positioning member 23 is inserted. With this configuration, the optical member 15 can be positioned with respective to the light guide member 19, chassis 14, and the LEDs 17 in a direction along the main plate surface (the planar direction), i.e., in the X-axis direction and the Y-axis direction. Specifically described, the second cutout 25 is provided in a pair in the optical member 15 at positions that correspond to the pair of cutouts 24 and the pair of positioning members 23. In other words, a pair of second cutouts 25 is provided such that each of the pair of second recesses 25 is provided at each end side in the X-axis direction on the upper end portions of the optical member 15. As illustrated in FIG. 7, the second cutout 25 is a hole extending through the optical member 15 in the thickness direction (Z-axis direction). The second cutout 25 opens only in the Z-axis direction and does not open in the X-axis direction and the Y-axis direction. The second cutout 25 has a substantially circular shape in a plan view so as to correspond to an outer shape of the positioning member 23. The diameter of the second cutout 25 is larger than that of the positioning member 23, so that the positioning member 23 can be inserted through the second cutout 25.

As illustrated in FIG. 7, an edge of the second cutout 25 can be in abutting contact with an outer surface of the positioning member 23 with the positioning member 23 being inserted through the second cutout 25. By orienting the plate surface of the optical member 15 so as to extend along the vertical direction, the edge of the second cutout 25 can be supported in the vertical direction by the positioning member 23. In other words, the optical member 15 can be suspended and supported with respect to the vertical direction by the positioning member 23, and thus the optical member 15 is less likely to be subjected to deformation such as wrinkling and warping due to its own weight. Further, the second cutout 25 is formed in the upper end portion of the optical member 15 and the upper end portion is suspended by the positioning member 23. Thus, substantially entire area of the optical member 15 in the vertical direction is less likely to be subjected to deformation such as wrinkling and warping. The above-described second cutout 25 is formed in all of the diffuser plate 15a and the optical sheet 15b included in the optical member 15 such that the second cutouts 25 formed in the optical members 15 correspond (are communicated) to each other.

As illustrated in FIG. 7, a through hole 26 is provided in the light-guide reflection sheet 22 attached to the surface 19c opposite to the light exit surface 19a of the light guide member 19. The positioning member 23 protruding toward the light guide member 19 from the bottom plate 14a is inserted through the through hole 26. The through hole 26 is provided in a pair on the light-guide reflection sheet 22 so as to correspond to the pair of cutouts 24. In other words, the pair of through holes 26 is provided such that each of the pair of the through holes 26 is provided at each end side in the X-axis direction on an upper end portion of the light-guide reflection sheet 22. The through hole 27 is a hole extending through the light-guide reflection sheet 22 in the thickness direction (Z-axis direction) like the second cutout 25. The through hole 26 opens only in the Z-axis direction and does not open in the X-axis direction and the Y-axis direction like the second cutout 25. The through hole 26 has a substantially circular shape in a plan view so as to correspond to an outer shape of the positioning member 23 like the second cutout 25. The diameter of the through hole 26 is larger than that of the positioning member 23, so that the positioning member 23 can be inserted through the through hole 26.

The configuration of the present embodiment has been explained above and an operation thereof will be explained. The liquid crystal display device 10 is manufactured by assembling the liquid crystal panel 11, the backlight unit 12, the bezel 13 and the like that are separately manufactured. Hereinafter, the manufacturing procedure of the liquid crystal display device 10 will be explained.

Initially, the second reflection sheet 21, the LED board 18, and the light guide member 19 are housed in the chassis 14. The light-guide reflection sheet 22 is integrally provided on the light guide member 19 in advance such that the through holes 26 and the cutouts 24 are communicated with each other. When such a light guide member 19 is housed in the chassis 14, the pair of cutouts 24 (the pair of through holes 26) is arranged so as to correspond to the pair of positioning members 23 provided on the bottom plate 14a. When the light guide member 19 is housed in the chassis 14, each of the pair of the positioning members 23 is inserted into the corresponding through hole 26 and cutout 24. This operation can be readily performed, because the cutout 24 extends through the light guide member 19 in the thickness direction and opens toward the LED 17 side. In this insertion operation, the positioning member 23 is brought in contact with the side surfaces 24a of the cutout 24, and thus the light guide member 19 and the light-guide reflection sheet 22 are positioned with respect to the chassis 14 in the direction along the main plate surface (the planar direction) thereof, i.e., in the X-axis direction and the Y-axis direction. In this state where the light guide member 19 is housed, the positioning member 23 extends through the light guide member 19 and a tip end portion thereof protrudes from the front surface of the light guide member 19 (FIG. 7).

Then, the optical member 15 is laminated on the light exit surface 19a of the light guide member 19. The diffuser plate 15a and the optical sheets 15b (the diffuser sheet, the lens sheet, the reflection-type polarizing sheet) included in the optical member 15 are provided on the light exit surface 19a of the light guide member 19 in this sequence. In this operation, the pair of second cutouts 25 formed in the optical member 15 is arranged so as to correspond to the pair of positioning members 23. When the optical member 15 is laminated on the light guide member 19, the positioning members 23 are inserted through the second cutouts 25. Accordingly, the optical member 15 is positioned with respect to the chassis 14 in the direction along the main plate surface (the planar direction) thereof, i.e., in the X-axis direction and the Y-axis direction. The second cutout 25 is communicated with the cutout 24 and the through hole 26 at this time. Subsequently, the frame 16 is attached to the chassis 14, and then the liquid crystal panel 11 and the bezel 13 are attached in this sequence to obtain the liquid crystal display device 10.

When the liquid crystal display device 10 manufactured as above is turned on, driving of the liquid crystal panel 11a is controlled by a control circuit that is not illustrated and driving of the LED 17 is controlled by driving power supplied to each LED 17 on the LED board 18 by a power supply board that is not illustrated. The light emitted from each LED 17 is guided by the light guide member 19 and applied to the liquid crystal panel 11 via the optical member 15. As a result, images are displayed on the liquid crystal panel 11. Hereinafter, operations of the backlight unit 12 will be explained. As illustrated in FIG. 5, when the LED 17 is turned on, the light emitted from the LED 17 enters the light entrance surface 19b of the light guide member 19. Although a predetermined space is provided between the LED 17 and the light entrance surface 19b, the space is optically-closed by the first and second reflection sheets 20, 21 provided on the front and rear side, respectively. Accordingly, the light emitted from the LED 17 is repeatedly reflected by the first and second reflection sheets 20, 21, and thus the light hardly leak out and efficiently enters the light entrance surface 19b.

The light entrance efficiency of the light from the LED 17 to the light guide member 19 depends on the positional relationship between the LED 17 and the light entrance surface 19b. If the positional relationship between the LED 17 and the light entrance surface 19b is changed, the light entrance efficiency changes accordingly. In the present invention, the positioning members 23 are used to position the light guide member 19 with respect to the chassis 14. Thus, the light guide member 19 is indirectly positioned with respect to the LEDs 17 on the LED board 18 fixed to the chassis 14. With this configuration, the positional relationship between the LEDs 17 and the light entrance surface 19b in the X-axis direction and the Y-axis direction can be held constant, and thus the light entrance efficiency of the light emitted from the LED 17 can be maintained. As a result, unevenness brightness is less likely to occur.

In addition to the above, as illustrated in FIG. 8, the cutouts 24 formed in the light guide member 19 each have a shape that narrows as a distance from the LED 17 increases. The cutouts 24 are arranged at a position that does not correspond to the LED 17 in the X-axis direction, i.e., the cutout 24 does not directly face the LED 17. In other words, the entire of the cutout 24 is in the non-irradiation area NLA and has a shape corresponding to the non-irradiation area NLA that is a substantially V shape, i.e., a triangular shape in a plan view. If the cutout has an opening toward the LED 17 side that has a constant width, a part of the cutout is in the irradiation area LA. Accordingly, the light from the LED 17 may easily enter the cutout, and thus the light traveling in the light guide member 19 may be unevenly distributed. As a result, dark portions may be formed in parts of the light guide member 19. To solve this problem, the distance between the adjacent LEDs 17 may be increased to enlarge the non-irradiation area NLA. However, in such a case, the density of LEDs 17 is lowered and the brightness cannot be improved. In addition, if the cutout is arranged so as to directly face the LED 17, the light from the LED 17 directly enters the cutout. As a result, the light traveling in the light guide member 19 may be highly unevenly distributed.

Unlike the above, in the present embodiment, the light emitted from the LED 17 is less likely to enter the cutout 24 and the light traveling in the light guide member 19 is evenly distributed, because the cutout 24 has the above-described configuration and arrangement. Accordingly, the dark portion is less likely to be formed in a part of the light guide member 19, and thus the light exiting from the light exit surface 19a is less likely to have uneven brightness. Further, the interval between the adjacent LEDs 17 is not required to be increased, because the non-irradiation area NLA can be maintained. Thus, the high density of the LEDs 17 can be maintained and brightness can be advantageously improved. In addition, compared with the case that the cutouts 24 that may form dark portions are arranged on a middle in the X-axis direction of the light guide member 19, the uneven brightness is less likely to occur in the present embodiment, because the cutout 24 of the present embodiment is arranged on each end side of the light guide member 19.

When the liquid crystal device 10 is in use, each LED 17 in the backlight unit 12 is turned on and off. This operation changes the temperature in the liquid crystal device 10, and thus the components of the liquid crystal display device 10 may be thermally expanded or thermally contracted. If the optical member 15 included in the components is thermally expanded or thermally contracted, the optical member 15 may be subjected to deformation such as warping and wrinkling. In such a case, the light transmitting through the optical member 15 may be unevenly distributed, leading to uneven brightness. In the present embodiment, the positioning member 23 is inserted through the second cutout 25 formed in the upper end portion of the optical member 15 such that the edge of the second cutout 25 is suspended and supported with respect to the vertical direction by the positioning member 23. Thus, even if the optical member is thermally expanded or thermally contracted, the optical member 15 is less likely to be subjected to deformation such as wrinkling and warping over the substantially entire area due to its own weight. This prevents uneven brightness to be caused by the thermal expansion or thermal contraction of the optical member 15.

As explained above, the backlight unit 12 of the present embodiment includes the LEDs 17 as the light sources, the light guide member 19, and the positioning member 23. The LED 17 faces the end portion of the light guide member 19. The positioning member 23 is capable of positioning the light guide member 19 with respect to the planar direction. The end portion of the light guide member 19 on the LED 17 side includes the cutout 24 through which the positioning member 23 is inserted. The cutout 24 is in a shape that narrow as a distance from the LED 17 increases.

With this configuration, the light guide member 19 can be positioned with respect to the planar direction thereof by inserting the positioning member 23 through the cutout 24 formed in the light guide member 19. This enables the positional relationship between the light guide member 19 and the LED 17 to be held constant and the light entrance efficiency of the light entering the light guide member 19 from the LED 17 to be stabilized. As a result, uneven brightness is less likely to occur. In addition, compared with the cutout that has a constant width, the light reaching the end portion of the light guide member 19 is less likely to enter the cutout 24 of the present embodiment, which is formed in the end portion of the light guide member 19, because the cutout 24 has a shape that narrows as a distance from the LED 17 increases. In the cutout 24 that has a constant width, the light reaching the end portion of the light guide member 19 may travel into the cutout 24. In such a case, the light may be reflected (totally-reflected) or refracted by the interface of the cutout 24. Accordingly, the light traveling in the light guide member 19 may be unevenly distributed. As a result, a dark portion where the amount of light is locally small may be formed on a portion of the light guide member 19, and thus uneven brightness may occur. However, according to the present embodiment, the light reaching the end portion of the light guide member 19 hardly enter the cutout 24. Accordingly, the light traveling in the light guide member 19 is less likely to be unevenly distributed. As a result, the dark portion is less likely to be formed on the light guide member 19, i.e., uneven brightness is less likely to occur.

The LEDs 17 are separately arranged on a line along the end portion of the light guide member 19. The positioning member 23 and the cutout 24 are not aligned with any one of the LEDs 17 on the line on which the LEDs 17 are arranged. With this configuration, the light from the LEDs 17 efficiently enters the end portion of the light guide member 19, because the LEDs 17 are separately arranged on a line along the end portion of the light guide member 19. Further, the light from the LED 17 hardly enter the cutout 24, because the positioning member 23 and the cutout 24 are not aligned with any one of the LEDs 17 on the line on which the LEDs 17 are arranged. Accordingly, uneven brightness is less likely to occur.

The positioning member 23 and the cutout 24 are arranged between the adjacent LEDs 17. This configuration is advantageous when there is no space for the cutout 24 on an end of a dimension of the light guide member 19 along an arrangement direction in which the LEDs 17 are arranged. In addition, even if the space between the adjacent LEDs 17 is reduced, the light from the LEDs 17 still hardly enter the cutout 24 compared with the cutout having the constant width, because the cutout 24 has a shape that narrows as a distance from the LED 17 increases. The density of the LEDs 17 can be increased by narrowing the space between the LEDs 17, and thus the brightness can be improved.

The adjacent LEDs 17 are equally spaced apart from the positioning member 23 and the cutout 24 that are arranged therebetween. With this configuration, the light from each of the adjacent LEDs 17 hardly enter the cutout 24, and thus uneven brightness is less likely to occur.

The cutout 24 is symmetrical with respect to a symmetric line passing through a midpoint between the adjacent light sources. With this configuration, the interfaces of the cutout 24 have the same positional relationship with respect to the adjacent LEDs 17. As a result, uneven brightness is less likely to occur.

The positioning member 23 and the cutout 24 includes a plurality of positioning members 23 and a plurality of cutouts 24, respectively. Each of the plurality of positioning members 23 are paired up with corresponding one the plurality of cutouts 24. The positioning members 23 and the cutouts 24 are arranged such that a distance between the pair of the positioning member 23 and the cutout 24 and the adjacent pair of the positioning member 23 and the cutout 24 is larger than an interval between the adjacent LEDs 17. With this configuration, the light guide member 19 can be properly positioned, because a plurality of pairs of the positioning members 23 and the cutouts 24 are provided. Further, the cutout 24 and the positioning member 23 that may form a dark portion are more sparsely arranged than the LEDs 17, and thus uneven brightness is less likely to occur.

The cutout 24 is provided close to an end of a dimension of the light guide member 19 along an arrangement direction in which the LEDs 17 are arranged. Uneven brightness is less likely to occur compared with the case that the cutout is arranged at a middle in the arrangement direction of the LEDs 17, because the cutout 24 that may form a dark portion is arranged close to the end of the dimension of the light guide member along the arrangement direction of the LEDs 17.

The cutout 24 is provided close to each end of the dimension of the light guide member 19 along the arrangement direction of the LEDs 17. In this configuration, uneven brightness is less likely to occur and the light guide member 19 is properly positioned.

The backlight unit 12 further includes the optical member 15 covering a light exit surface of the light guide member 19. The optical member 15 includes a second cutout 25 that is communicated with the cutout 24 and through which the positioning member 23 is inserted. By inserting the positioning member 23 through the cutout 24 and the second cutout 25, the light guide member 19 and the optical member 15 can be positioned at the same time.

The second cutout 25 is a hole extending through the optical member 15 in the thickness direction thereof, and the edge of the hole is supported by the positioning member 23 with respect to the vertical direction. By inserting the positioning member 23 through the second cutout 25, the edge of the hole of the second cutout 25 is supported by the positioning member 23 with respect to the vertical direction. In other words, the optical member 15 is suspended and supported by the positioning member 23. Thus, even if the optical member 15 is thermally expanded or thermally contracted, the optical member 15 is less likely to be subjected to deformation such as wrinkling and warping due to its own weight. Thus, uneven brightness is less likely to occur.

The second cutout 25 is formed in the upper end portion of the optical member 15 in the vertical position. With this configuration, the upper end portion of the optical member 15 can be suspended and supported by the positioning member 23. As a result, the optical member 15 is less likely to be subjected to deformation such as wrinkling and warping substantially over the entire area in the vertical direction. Thus, uneven brightness is less likely to occur.

The LEDs 17 are provided so as to face both of the upper end portion and the lower end portion of the light guide member 19 in the vertical position. With this configuration, brightness can be improved. Even if the size of the backlight unit 12 is increased, sufficient brightness can be achieved. As a result, the size of the backlight unit 12 can be increased.

The cutout 24 has the opening toward the LED 17 side. With this configuration, the positioning member 23 can be easily inserted through the cutout 24, compared with a cutout having a closed outer periphery. This facilitates the assembly.

The opening of the cutout 24 has the width that gradually decreases as a distance from the LED 17 increases. With this configuration, the light from the LED 17 hardly enter the cutout 14.

The cutout 24 has a triangular shape in a plan view. With this configuration, the interface of the cutout 24 is inclined with respect to an arrangement direction in which the LED 17 and the light guide member 19 are arranged. Thus, the light from the LED 17 is less likely to enter the cutout 24.

The cutout 24 has an isosceles triangle shape in a plan view. The cutout 24 has a symmetrical shape in this configuration. Thus, this configuration is preferable when two LEDs 17 are arranged so as to sandwich the cutout 24.

The cutout 24 extends through the light guide member 19 in the thickness direction thereof. The cutout 24 can be readily formed through the light guide member 19 in this configuration. This is advantageous in the production of the light guide member 19.

The backlight unit 12 further include the chassis 14 housing the LED 17 and the light guide member 19. The positioning member 23 is integrally formed with the chassis 14. With this configuration, the light guide member 19 is positioned by the positioning member 23, and thus the appropriate positional relationship between the LEDs 17 and the light guide member 19 can be maintained.

The positioning member 23 has a columnar shape. With this configuration, the positioning member 23 can be readily inserted through the cutout 24, and thus this configuration facilitates the assembly.

The backlight unit 12 further includes the light-guide reflection sheet 22 as the reflector. The light-guide reflection sheet 22 covers the surface opposite to the light exit surface of the light guide member 19. The light-guide reflection sheet 22 includes the through hole 26 that is communicated with the cutout 24 and through which the positioning member 23 is inserted. The light traveling in the light guide member 19 can be reflected toward the light exit side by the light-guide reflection sheet 22, and thus the light can efficiently exit from the light guide member 19. By inserting the positioning member 23 through the cutout 24 and the through hole 26, not only the light guide member 19, but also the light-guide reflection sheet 22 can be positioned.

The backlight unit 12 further includes the light source board 18 on which the LEDs 17 are mounted. With this configuration, the arrangement of the LEDs 17 and wiring of the LEDs 17 can be facilitated.

The light sources are the LEDs 17. This improves brightness and reduces power consumption.

The first embodiment of the present invention has been illustrated. However, the present invention is not limited to the above embodiment, and may employ following various modifications, for example. In the following modifications, the same members as those of the above embodiment are indicated by the same symbols, and will not be explained.

### First Modification of First Embodiment

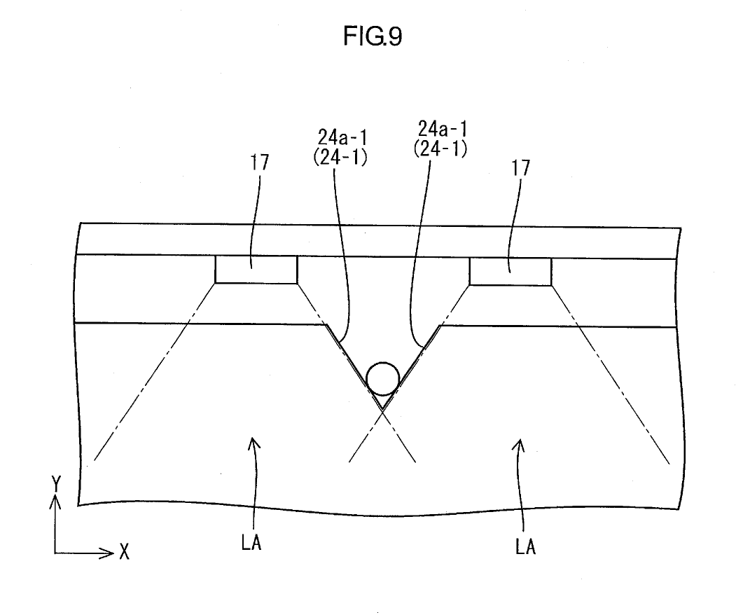

The first modification of the first embodiment will be explained with reference to FIG. 9. The shape of a cutout 24-1 differs from that of the cutout 24.

As illustrated in FIG. 9, the cutout 24-1 of the first modification has a triangular shape in a plan view. The cutout 24-1 has side surfaces 24a-1 each of which substantially matches and extends parallel to a one-dotted line that indicates the outermost of the irradiation area LA of the LED 17. With this configuration, the light emitted from the LED 17 hardly enter the cutout 24-1.

### Second Modification of First Embodiment

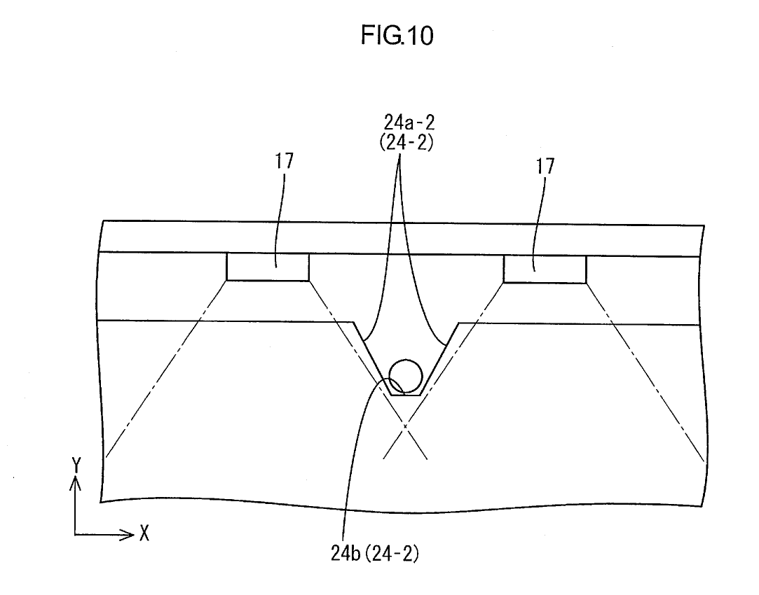

The second modification of the first embodiment will be explained with reference to FIG. 10. The shape of a cutout 24-2 differs from that of the cutout 24.

As illustrated in FIG. 9, the cutout 24-2 of the second modification has a trapezoidal shape in a plan view. The cutout 24-2 includes a pair of side surfaces 24a-2 and a surface 24b. The side surfaces 24a-2 incline with respect to the Y-axis direction and the X-axis direction. The surface 24b connects ends of the side surfaces 24a-2 on the side opposite to the LED 17 side and extends parallel to the X-axis direction. With this configuration, the light emitted from the LED 17 hardly enter the cutout 24-2.

As described above, the cutout 24-2 of the present modification has a trapezoidal shape in a plan view. In such a configuration, the side surfaces 24a-2 (the interfaces) of the cutout 24-2 includes a portion inclined with respect to the arrangement direction of the LED 17 and the light guide member 19. Thus, light emitted from the LED 17 hardly enter the cutout 24-2.

### Third Modification of First Embodiment

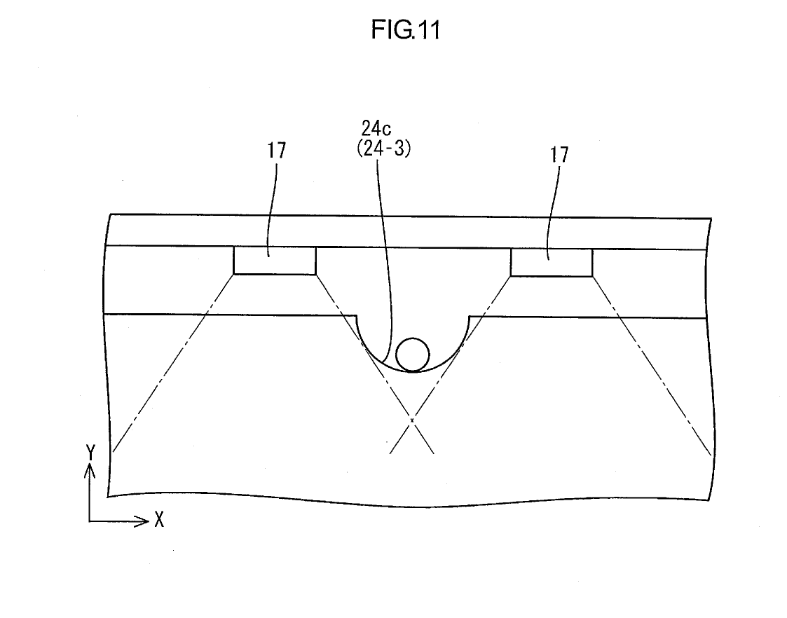

The third modification of the first embodiment will be explained with reference to FIG. 11. The shape of a cutout 24-3 differs from that of the cutout 24.

As illustrated in FIG. 11, the cutout 24-3 of the third modification has a semicircular shape in a plan view. The cutout 24-3 has a side surface 24c that has an arc-like shape having a constant curvature over the entire area thereof. The cutout 24-3 has an opening toward the LED 17 side. The opening has a width equal to the diameter of the imaginary circle formed by the cutout 24-3. With this configuration, the light emitted from the LED 17 hardly enter the cutout 24-3.

As described above, the cutout 24-3 of the present modification has a substantially semicircular shape in a plan view. In this configuration, the side surface 24c (the interface) of the cutout 24-3 has an arc-like shape, and thus light emitted from the LED 17 hardly enter the cutout 24-3.

### Fourth Modification of First Embodiment

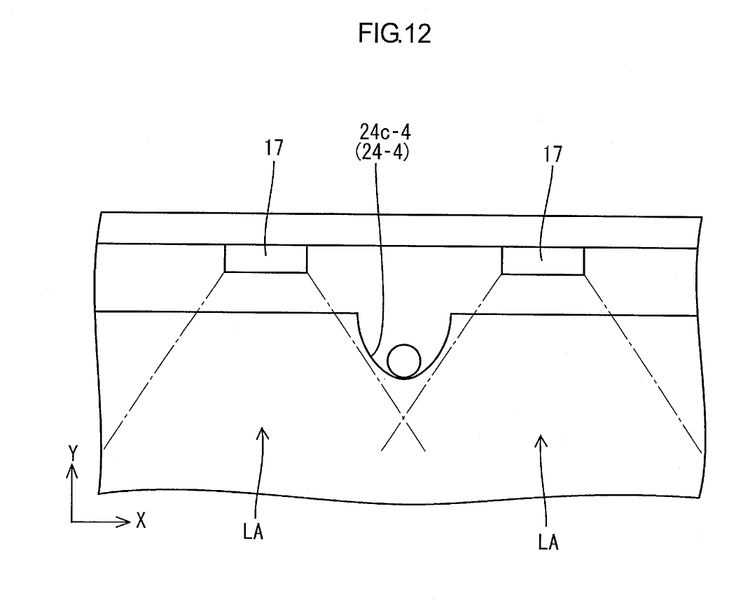

The fourth modification of the first embodiment will be explained with reference to FIG. 12. The shape of a cutout 24-4 differs from that of the cutout 24.

As illustrated in FIG. 12, the cutout 24-4 of the fourth modification has a semielliptical shape in a plan view. The cutout 24-4 has a shape obtained by cutting an ellipse in half along the short-axis direction thereof. The long-axis direction thereof matches the Y-axis direction and the short-side direction thereof matches the X-axis direction. The opening of the cutout 24-4 toward the LED 17 side has a width equal to the length of the short axis of the ellipse forming the cutout 24-4. In such a configuration, light emitted from the LED 17 hardly enter the cutout 24-4. The shape of the side surface can be appropriately changed depending on the positional relationship with respect to the LED 17 (the irradiation area LA) by suitably changing at least one of the lengths of the long axis and the short axis of the ellipse.

As described above, the cutout 24-4 of the present modification has a substantially semielliptical shape in a plan view. With this configuration, the shape of the side surface 24c-4 (the interface) of the cutout 24-4 can be readily changed depending on the positional relationship between the LED 17 and the cutout 24-4.

### Fifth Modification of First Embodiment

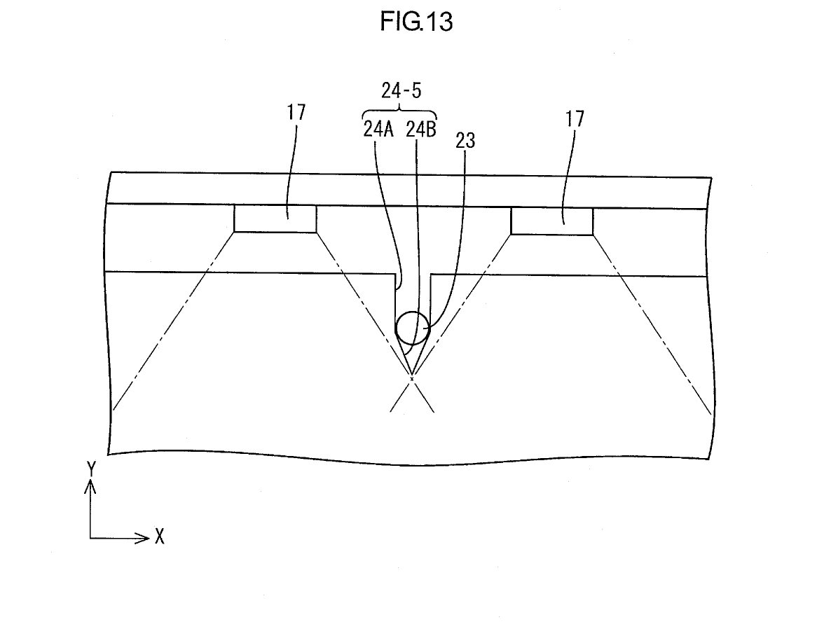

The fifth modification of the first embodiment will be explained with reference to FIG. 13. The shape of a cutout 24-5 differs from that of the cutout 24.

As illustrated in FIG. 13, the cutout 24-5 of the fifth modification includes a first portion 24A and a second portion 24B. The first portion 24A has an opening toward the LED 17 side that has a uniform width, and the second portion 24B has an opening toward the LED 17 side that has a non-uniform width. The first portion 24A is arranged on the LED 17 side and the second portion 24b is arranged on the side opposite to the LED 17 side. The opening of the first portion 24A has a width substantially equal to the diameter of the positioning member 23. The opening of the second portion 24B has a width that becomes gradually smaller in a direction away from the LED 17. The shape of the second portion 24B in a plan view is an isosceles triangle. With this configuration, the light emitted from the LED 17 hardly enter the cutout 24-5.

### Second Embodiment

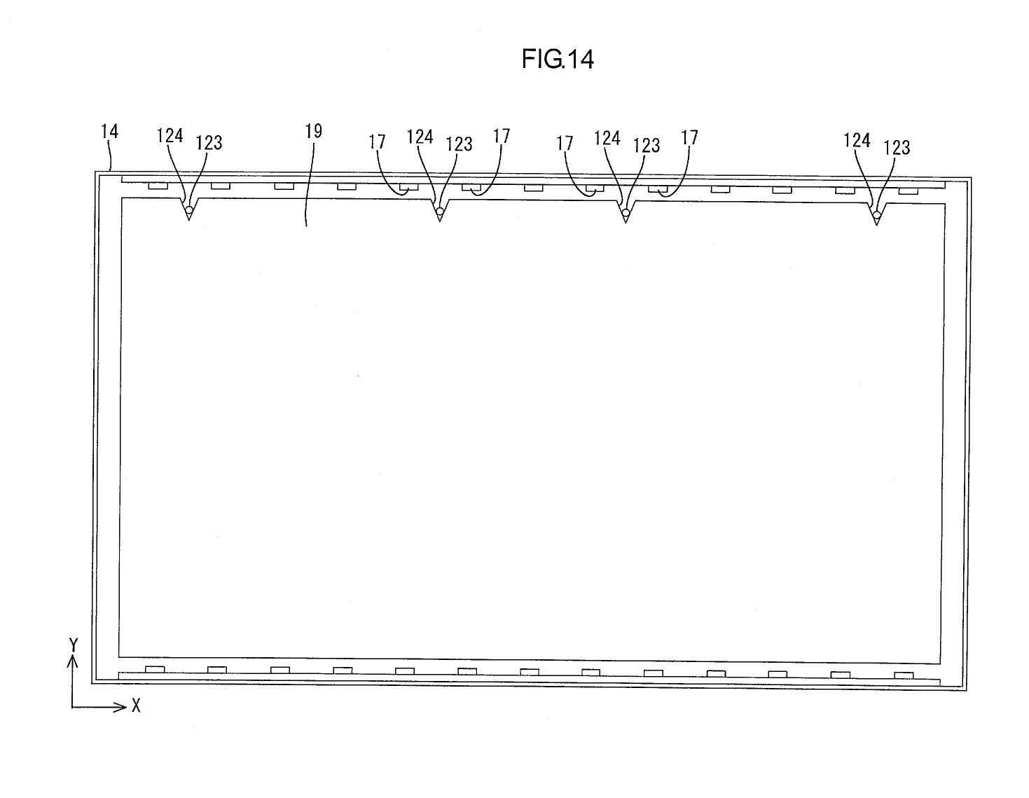

The second embodiment of the present invention will be explained with reference to FIG. 14. In the second embodiment, the number of positioning members 123 and cutouts 124 differs from that of the first embodiment. Similar configurations, operations, and effects to those of the first embodiment will not be explained.

As illustrated in FIG. 14, four positioning members 123 and four cutouts 124 are paired up and separately arranged on upper end portion of the chassis 14 and the light guide member 19 in the vertical position with a predetermined intervals therebetween in the X-axis direction. The positioning members 123 and the cutouts 124 are each arranged at a middle between the adjacent LEDs 17 (at a non-irradiated area). The light guide member 19 can be more properly positioned by increasing the number of positioning members 123 and cutouts 124. The number of the positioning members 123 and the cutouts 124 may be five or more, or may be three.

### Third Embodiment

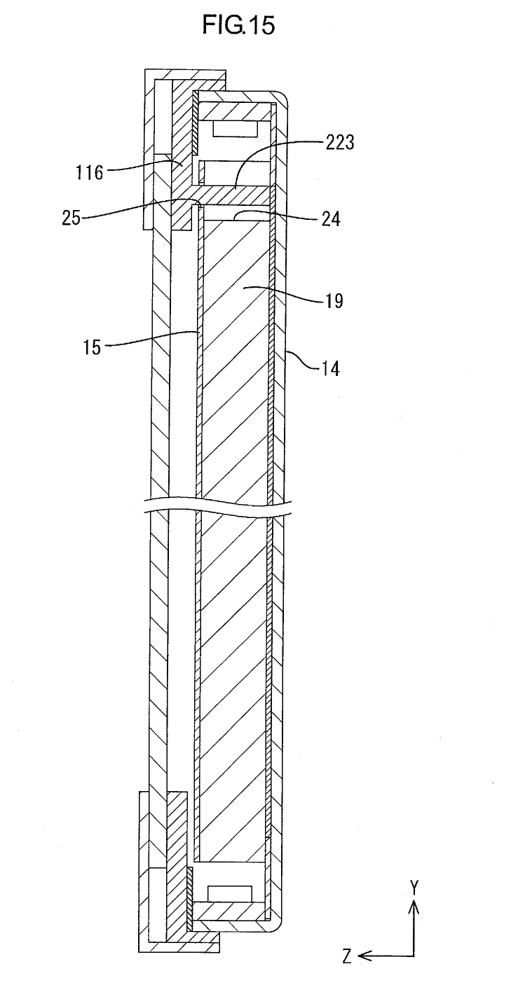

The third embodiment of the present invention will be explained with reference to FIG. 15. In the third embodiment, a positioning member 223 is provided on a frame 116. Similar configurations, operations, and effects to those of the first embodiment will not be explained.

As illustrated in FIG. 15, the positioning member 223 is integrally formed on the frame 116. The frame 116 surrounds an outer peripheral end of the light guide member 19. The positioning member 223 extends from an upper end portion (a portion along the long side) of the frame 116 toward the rear side. The positioning member 223 is inserted through the second recess 25 formed in the optical member 15 and the cutout 24 formed in the light guide member 19 in this sequence from the front side.

The present embodiment includes the chassis 14 housing the LEDs 17 and the light guide member 19, and a frame 116 attached to the chassis 14. The frame 116 is capable of holding down the light guide member 19 from a light exit side. The positioning member 223 is integrally formed on the frame 116. With this configuration, the light guide member 19 is positioned by the positioning member 223 that is integrally formed on the frame 116, and thus an appropriate positional relationship between the LEDs 17 and the light guide member 19 can be maintained.

### Fourth Embodiment

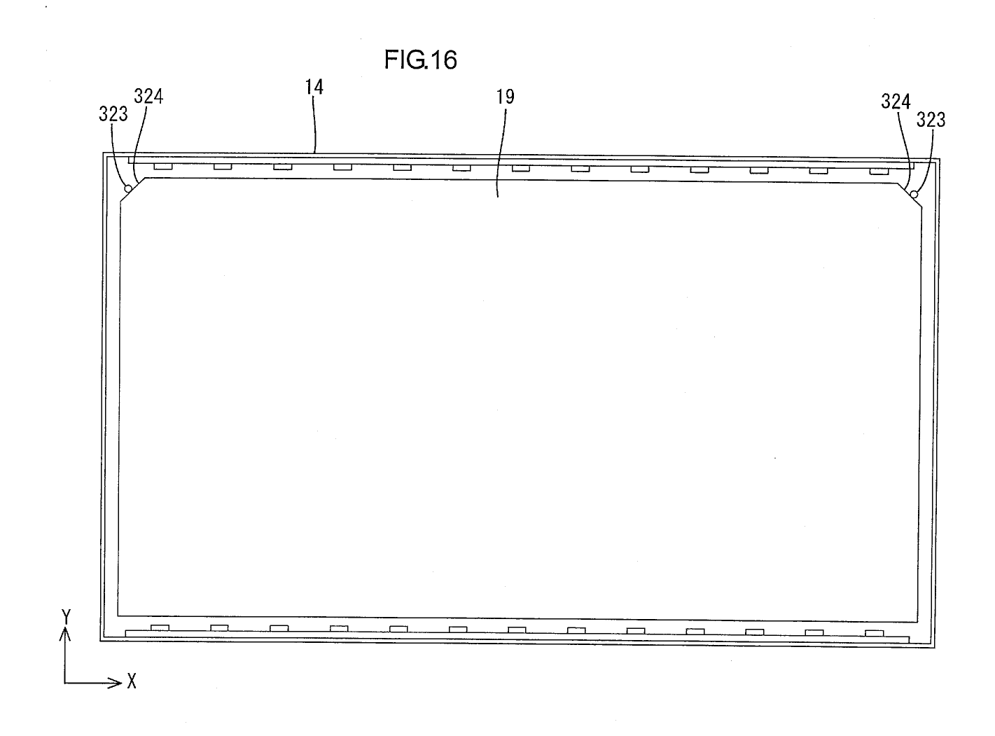

The fourth embodiment of the present invention will be explained with reference to FIG. 16. In this embodiment, the configuration of a cutout 324 differs from that of the cutout in the above embodiments. Similar configurations, operations, and effects to those of the first embodiment will not be explained.

As illustrated in FIG. 16, a pair of cutouts 324 according to this embodiment is formed by cutting corner portions of the light guide member 19. The corner portions are positioned at ends in the X-axis direction on the upper end portion in the vertical direction. Each of the pair of cutouts 324 is positioned on the respective end sides in the X-axis direction than one of the LEDs 17 that is arranged at the most distal ends of the LEDs 17 linearly arranged in the X-direction. The positions of positioning members 323 on the chassis 14 are determined depending on the positions of the above cutouts 324. Although not illustrated, preferably, the positions of the second cutouts formed in the optical member are also determined depending on the positions of the above cutouts 324.

### Other Embodiments

The present invention is not limited to the above embodiments described in the above description and the drawings. The following embodiments are also included in the technical scope of the present invention, for example.

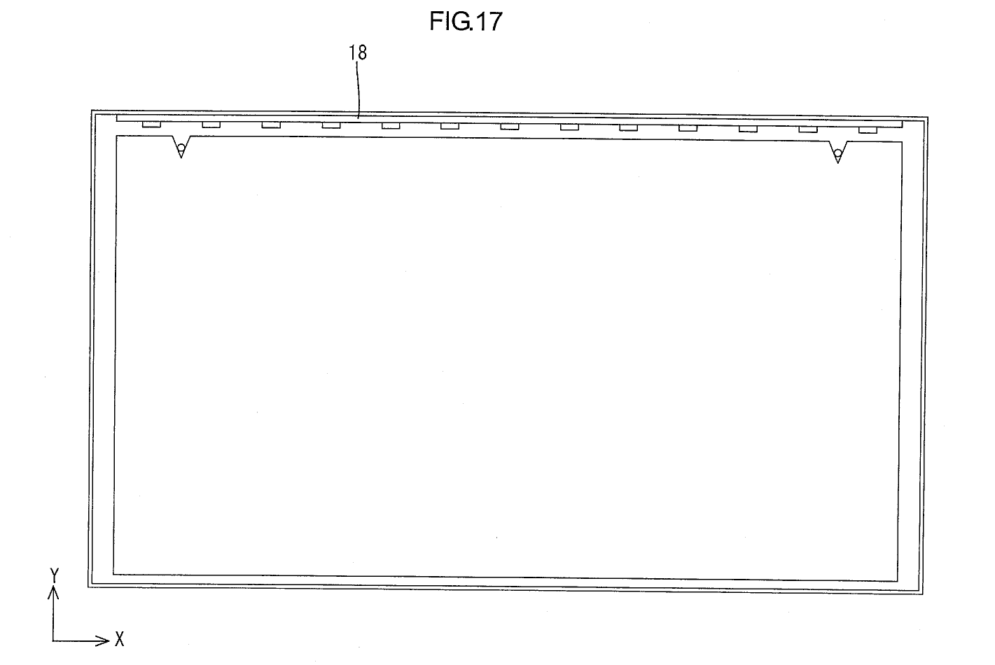

(1) In the above embodiments, each of the pair of LED boards is provided on the upper and lower sides in the vertical direction (on the long sides). However, the number of the LED board may be suitably changed. For example, as illustrated in FIG. 17, the LED board 18 may only be provided on the upper side in the vertical direction and may not be provided on the lower side. Such configuration is particularly preferable in a liquid crystal display device (backlight device) having a small screen. This can reduce the production cost thereof. Alternatively, three or four LED boards may be provided. Specifically, the LED board may be provided on at least one of the right and left sides in the horizontal direction in addition to the upper and lower sides in the vertical direction. The LED board may be provided on the right and left sides in the horizontal direction, and in addition to that, the LED board may be provided on at least one of the upper and lower direction in the vertical direction.

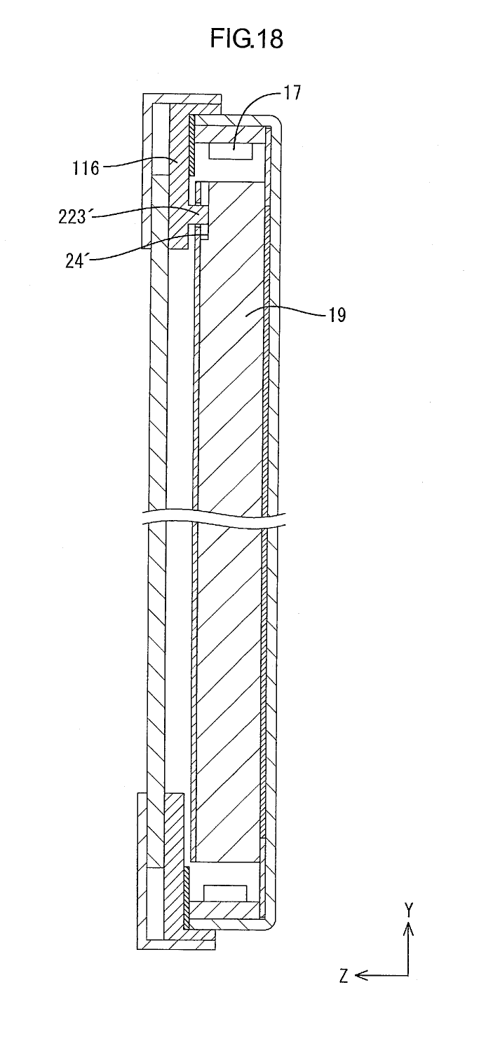

(2) A modification of the above-described third embodiment is illustrated in FIG. 18. A cutout 24′ does not extend through the light guide member 19 in the thickness direction thereof. The cutout 24′ has a concave shape opening toward the front side, i.e., the positioning member 223′ side, and the LED 17 side. The cutout 24′ has a depth that does not overlap with the LED 17 in the Z-axis direction. The positioning member 223′ protrudes from the frame 116 with a length shorter than that in the third embodiment.

(3) In the above embodiments, the LED board is arranged on the long sides of the light guide member. However, the LED board may be arranged on the short sides of the light guide member. The number of the LED board may be one and may be arranged on one of the short sides of the light guide member.

(4) In the above first embodiment, the cutout and the positioning member (the second cutout) are provided on each end side in the long-side direction of the backlight unit. However, the cutout and the positioning member (the second cutout) may be provided on a relatively middle in the long-side direction.

(5) In the above embodiments, the cutout and the positioning member (the second cutout) are provided on the upper portion of the backlight unit in the vertical direction. However, the cutout and the positioning member (the second cutout) may be provided on a middle portion or a lower portion of the backlight unit in the vertical direction.

(6) The shape of the cutout may be suitably altered from those in the above first embodiment and the modifications. For example, the shape of the cutout may be non-symmetrical triangle or trapezoid. Further, the specific shape and size of the positioning member may be suitably altered. For example, the shape of the positioning member may be square column, conical shape, or pyramid shape.

(7) In the above embodiments, the cutout has an opening toward the LED side. However, the cutout may be a hole that does not have an opening.

(8) In the above embodiments, the outer periphery of the second cutout is closed (endless ring shape). However, in the present invention, the outer periphery of the second cutout may be partially opened (closed-end ring shape).

(9) In addition to the above (8), the second cutout may have a concave shape that does not extend through the optical member.

(10) In the above first and third embodiments, the positioning member is integrally provided with the chassis or the frame. However, the positioning member may be provided as a separate member from the chassis and the frame. In such a case, the positioning member is bonded to the chassis or the frame.

(11) In the above embodiments, the optical member includes the diffuser plate and the three optical sheets. However, the kind and the number of the optical member may be suitably altered.

(12) In the above embodiments, the second cutout is formed in the optical member. However, the second cutout may not be formed. In addition, the through hole formed in the light guide reflection sheet may not be formed.

(13) In the above embodiments, the LED includes an LED chip emitting light of single color of blue and the LED emits white light by a fluorescent material. The LED may include an LED chip emitting ultraviolet rays (blue-violet rays) and emit white light by a fluorescent material.

(14) In the above embodiments, the LED includes an LED chip emitting light of single color of blue and emits white light by a fluorescent material. However, the LED may include three different kinds of LED chips each of which emits a single color of light of red, green or blue. The LED may include three different kinds of LED chips each of which emits a single color of light of cyan (C), magenta (M) or yellow (Y).

(15) In the above embodiments, the LED is used as a light source. However, a light source other than the LED such as an organic LED may be used.

(16) In the above embodiments, the liquid crystal panel is arranged in a vertical position such that the short-side direction thereof matches the vertical direction. However, the liquid crystal panel may be arranged in a vertical position such that the long-side direction matches the vertical direction.

(17) In the above embodiments, TFTs are used as switching components of the liquid crystal display device. However, the technology described above can be applied to liquid crystal display devices including switching components other than TFTs (e.g., thin film diode (TFD)). Further, the technology can be applied to not only color liquid crystal display devices but also black-and-white liquid crystal display devices.

(18) In the above embodiments, the liquid crystal display device includes the liquid crystal panel as a display panel. The technology can be applied to display devices including other types of display panel.

(19) In the above embodiments, the television receiver including the tuner is used. However, the technology can be applied to a display device without a tuner.

### EXPLANATION OF SYMBOLS

10: liquid crystal display device (display device), 11: liquid crystal panel (display panel), 12: backlight unit (lighting device), 14: chassis, 15: optical member, 16, 116: frame, 17: LED (light source), 18: LED board (light source board), 19: light guide member, 19a: light exit surface, 22: light-guide reflection sheet (reflector), 23, 123, 223, 323: positioning member, 24, 124, 324: cutout, 24a, 24c: side surface (interface), 25: second cutout, 26: through hole, TV: television receiver

1. A lighting device comprising:
light sources;
a light guide member having an end portion facing the light source, the end portion including a cutout in a shape that narrows as a distance from the light source increases; and
a positioning member inserted through the cutout, the positioning member being capable of positioning the light guide member with respect to a planar direction thereof.

2. The lighting device according to claim 1, wherein:
the light sources are separately arranged on a line along the end portion of the light guide member; and
the positioning member and the cutout are not aligned with any of the light sources on the line on which the light sources are arranged.

3. The lighting device according to claim 2, wherein the positioning member and the cutout are arranged between the adjacent light sources.

4. The lighting device according to claim 3, wherein the adjacent light sources are equally spaced apart from the positioning member and the cutout that are arranged therebetween.

5. The lighting device according to claim 4, wherein the cutout is symmetrical with respect to a symmetric line passing through a midpoint between the adjacent light sources.

6. The lighting device according to claim 2, wherein:
the positioning member and the cutout comprises a plurality of positioning members and a plurality of cutouts, respectively, each of the plurality of positioning members being paired up with corresponding one of the plurality of cutouts; and
the positioning members and the cutouts are arranged such that a distance between the pair of the positioning member and the cutout and the adjacent pair of the positioning member and the cutout is larger than an interval between the adjacent light sources.

7. The lighting device according to claim 2, wherein the cutout is provided close to an end of a dimension of the light guide member along an arrangement direction in which the light sources are arranged.

8. The lighting device according to claim 7, wherein the cutout is provided close to each end of the dimension of the light guide member along the arrangement direction of the light sources.

9. The lighting device according to claim 2, further comprising an optical member covering a light exit surface of the light guide member, the optical member including a cutout that is communicated with the cutout of the light guide member and through which the positioning member is inserted.

10. The lighting device according to claim 9, wherein the cutout of the optical member is a hole extending through the optical member in a thickness direction thereof, and an edge of the hole is supported by the positioning member with respect to the vertical direction.

11. The lighting device according to claim 10, wherein the cutout of the optical member is formed in an upper end portion of the optical member in a vertical position.

12. The lighting device according to claim 11, wherein the light sources are provided so as to face an upper end portion and a lower end portion of the light guide member in the vertical position.

13. The lighting device according to claim 1, wherein the cutout of the light guide member has an opening toward the light source side.

14. The lighting device according to claim 13, wherein the opening of the cutout of the light guide member has a width that gradually decreases as a distance from the light source increases.

15. The lighting device according to claim 14, wherein the cutout of the light guide member has a triangular shape in a plan view.

16. The lighting device according to claim 15, wherein the cutout of the light guide member has an isosceles triangle shape in a plan view.

17. The lighting device according to claim 14, wherein the cutout of the light guide member has a trapezoidal shape in a plan view.

18. The lighting device according to claim 14, wherein the cutout of the light guide member has a substantially semicircular shape in a plan view.

19. The lighting device according to claim 14, wherein the cutout of the light guide member has a substantially semielliptical shape in a plan view.

20. The lighting device according to claim 19, wherein the cutout extends through the light guide member in the thickness direction thereof.

21. The lighting device according to claim 1, further comprising a chassis housing the light source and the light guide member,
wherein the positioning member is integrally formed with the chassis.

22. The lighting device according to claim 1, further comprising:
a chassis housing the light source and the light guide member; and
a frame attached to the chassis, the frame being capable of holding down the light guide member from a light exit side,
wherein the positioning member is integrally formed with the chassis.

23. The lighting device according to claim 1, wherein the positioning member has a columnar shape.

24. The lighting device according to claim 1, further comprising a reflector covering a surface opposite to a light exit surface of the light guide member,
wherein the reflector includes a through hole that is communicated with the cutout of the light guide member and through which the positioning member is inserted.

25. The lighting device according to claim 1, further comprising a light source board on which the light sources are mounted.

26. The lighting device according to claim 1, the light sources are LEDs.

27. A display device comprising:
the lighting device according to claim 1; and
a display panel configured to display using light emitted from the lighting device.

28. The display device according to claim 27, wherein the display panel is a liquid crystal panel including a pair of substrates with liquid crystals sealed therebetween.

29. A television receiver comprising the display device according to claim 27.
